(19) United States
(12) Patent Application Publication
(10) Pub. No.: US 2026/0358289 A1
(43) Pub. Date: Nov. 12, 2026

(54) SENSOR ELEMENT AND GAS SENSOR

(71) Applicant: Niterra Co., Ltd., Nagoya-shi (JP)

(72) Inventors: Yasumitsu SHIMIZU, Nagoya-shi (JP); Futa AOSHIMA, Nagoya-shi (JP); Hitoshi FURUTA, Nagoya-shi (JP); Takuya DOI, Nagoya-shi (JP)

(73) Assignee: Niterra Co., Ltd., Nagoya-shi (JP)

(21) Appl. No.: 19/130,005

(22) PCT Filed: Dec. 25, 2023
(86) PCT No.: PCT/JP2023/046372

§ 371 Date: May 14, 2025

(30) Foreign Application Priority Data
Jan. 12, 2023 (JP) 2023-002951

(51) Int. Cl. G01N 27/406

(52) U.S. Cl. CPC G01N 27/4062

(57) ABSTRACT

A sensor element comprising: a pair of electrodes; and a pair of leads, respectively connected to the pair of electrodes, wherein one of the pair of leads is an internal lead disposed inside the sensor element, and a part of the one of the pair of leads faces a communication hole provided in the sensor element, to be in communication with an outside, the internal lead is configured to include noble metal particles of one type or more selected from the group of Pt, Pd, Rh, and Au, ceramic particles, and pores, a porosity of the internal lead is more than 0% and 11% or less, and a proportion of a total area of large-diameter pores each having a cross-sectional area of 5 μm² or more relative to a total area of the pores in a cross section of the internal lead accounts for 8% or more.

### CROSS-REFERENCE TO RELATED PATENT APPLICATIONS

This application is a U.S. National Phase Application under 35 U.S.C. § 371 of International Patent Application No. PCT/JP2023/046372 filed on Dec. 25, 2023, which claims the benefit of priority to Japanese Application No. 2023-002951 filed on Jan. 12, 2023, the contents of all which are incorporated herein by reference in their entireties. The International Application was published in Japanese on Jul. 18, 2024 as International Publication No. WO/2024/150656 under PCT Article 21(2).

### FIELD OF THE INVENTION

The present invention relates to: a sensor element and a gas sensor suitably used for detecting the concentration of a specific gas contained in combustion gas or exhaust gas from a combustor, an internal combustion engine, or the like, for example.

### BACKGROUND OF THE INVENTION

To date, a gas sensor for detecting the concentration of a specific component (e.g., oxygen) in exhaust gas from an internal combustion engine has been known. A gas sensor of this type includes therein a sensor element having an elongated plate shape. A front end portion of the sensor element is provided with a detection portion for detecting the specific component(Japanese Patent Application Laid-Open (kokai) JP2022-032240).

The detection portion is composed of a pair of electrodes and a solid electrolyte, and a lead extends from each electrode toward the rear end side. Here, there is a detection portion having a structure in which voids are formed inside a reference lead portion connected to a reference electrode, such that communication is allowed between gases inside and outside the element via the reference lead portion, whereby the pressure of a reference gas around the reference electrode is adjusted.

### PRIOR ART DOCUMENT

### Patent Document

Patent Document 1: Japanese Patent Application Laid-Open (kokai) JP2022-032240

### Problem to be Solved by the Invention

When water having entered a gas sensor or water generated due to condensation comes into contact with a sensor element, a lead absorbs the water having entered through a communication hole, and when the sensor element is heated thereafter, water vaporizes and expands inside the lead, whereby breakage or disconnection of the lead may be caused.

An object of the present invention is to provide a sensor element and a gas sensor that suppress disconnection due to entry of water into a lead that is connected to an electrode and that faces a communication hole to be in communication with the outside.

### SUMMARY OF THE INVENTION

### Means for Solving the Problems

In order to solve the above problem, a sensor element comprising: a pair of electrodes; and a pair of leads respectively connected to the pair of electrodes, wherein one of the pair of leads is an internal lead disposed inside the sensor element, and a part of the one of the pair of leads faces a communication hole provided in the sensor element and communicates with an outside, the internal lead is configured to include noble metal particles, ceramic particles and pores, said noble metal particles being one or more elements selected from the group consisting of Pt, Pd, Rh, and Au, a porosity of the internal lead is in a range of more than 0% and 11% or less, and a proportion RA of a total area of large-diameter pores each having a cross-sectional area of 5 μm² or more relative to a total area of the pores in a cross section of the internal lead accounts for 8% or more.

According to this sensor element, since the porosity of the internal lead is in the range of more than 0% and 11% or less, the pressure of a reference gas around a reference electrode can be adjusted with moderate gas permeability. In addition, it is possible to suppress occurrence of disconnection caused by noble metal particles being divided by pores due to a high porosity.

Since the proportion RA of the total area of the large-diameter pores is 8% or more, water absorbed in the internal lead from the large-diameter pores is easily released toward the communication hole. As a result, it is possible to suppress an incident that, when heating is performed after water has entered the sensor element, water vaporizes and expands inside the internal lead to cause breakage or disconnection of the internal lead.

In the sensor element of the present invention, the proportion RA may be less than 60%.

According to this sensor element, peeling off of the internal lead can be suppressed.

A gas sensor of the present invention is a gas sensor comprising: the sensor element according to claim 1 or 2; and a metal shell holding the sensor element.

### Effects of the Invention

The present invention makes it possible to provide a sensor element and a gas sensor that suppress disconnection due to entry of water into a lead that is connected to an electrode and that faces a communication hole to be in communication with the outside.

### BRIEF DESCRIPTION OF THE DRAWINGS

FIG. 1 is a cross-sectional view of a gas sensor cut along the direction of an axial line thereof.

FIG. 2 is an exploded perspective view schematically showing a detection element portion and a heater portion forming a sensor element.

FIG. 3 is a view illustrating a cross-sectional SEM image including a first lead portion of Example 1.

FIG. 4 is a view illustrating a cross-sectional SEM image including a first lead portion of Comparative Example 1.

### DETAILED DESCRIPTION OF THE INVENTION

Hereinafter, an embodiment of the present invention will be described.

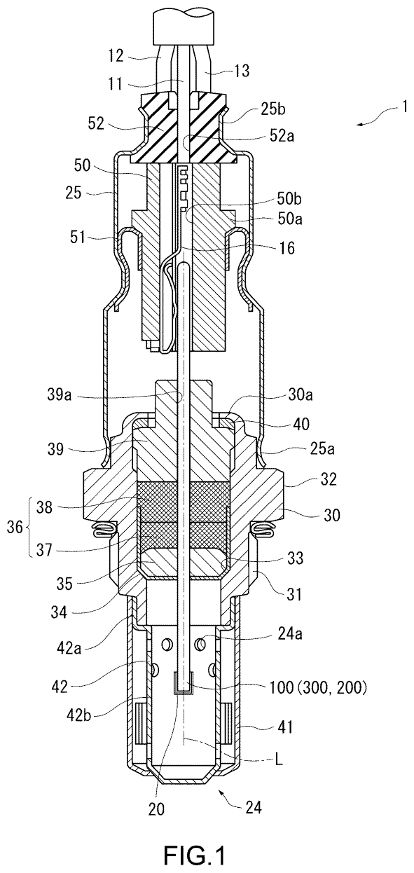

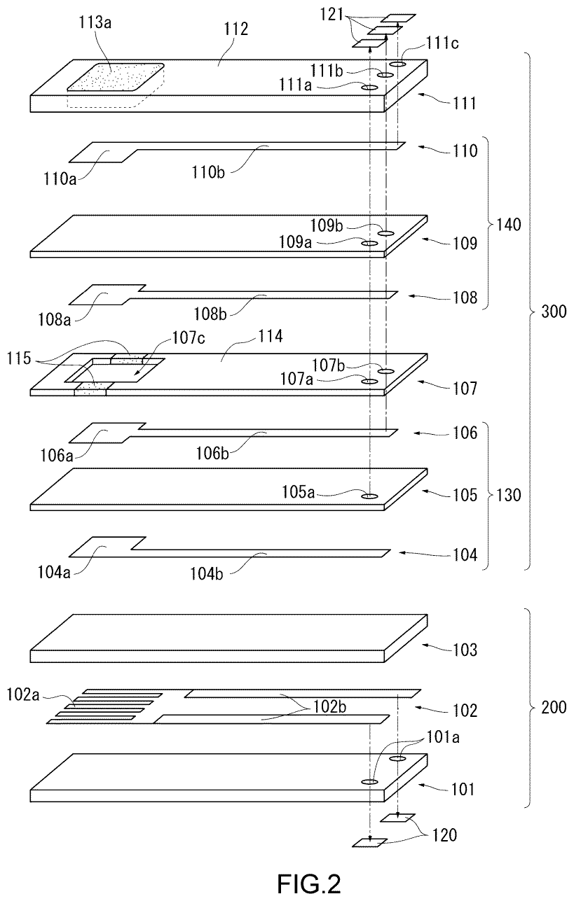

First, a configuration of a gas sensor (oxygen sensor) 1 including a sensor element 100 according to the present embodiment is described. FIG. 1 is a cross-sectional view of the gas sensor 1 cut along a direction of an axial line L. FIG. 2 is an exploded perspective view schematically showing a detection element portion 300 and a heater portion 200 forming the sensor element 100. In the present specification, the lower side of the gas sensor 1 shown in FIG. 1 will be referred to as “front end side” and the opposite side (upper side in FIG. 1) thereto will be referred to as “rear end side”.

As shown in FIG. 1, the gas sensor 1 includes: the sensor element 100 implemented as a stacked body of the detection element portion 300 and the heater portion 200; a metal shell 30 which holds the sensor element 100 and the like so as to be accommodated therein; and a protector 24 that is mounted to a front end portion of the metal shell 30. The sensor element 100 has an elongated plate shape as a whole, and is disposed such that the longitudinal direction thereof extends along the direction of the axial line L. As described later, a porous protection layer 20 is formed on the front end side of the sensor element 100.

As shown in FIG. 2, the heater portion 200 has an elongated plate shape as a whole, and includes a first base body 101 and a second base body 103 which each contain alumina as a main material; and a heating element 102 which is sandwiched by the first base body 101 and the second base body 103 and which contains platinum as a main material. The heating element 102 includes: a heat generation portion 102a positioned on the front end side; and a pair of heater lead portions 102b extending from the heat generation portion 102a along the longitudinal direction (the direction of the axial line L) of the first base body 101. Ends of the heater lead portions 102b are electrically connected to heater-side pads 120, respectively, via conductors formed in heater-side through-holes 101a provided in the first base body 101.

Similar to the heater portion 200, the detection element portion 300 has an elongated plate shape as a whole, and includes an oxygen concentration detection cell 130 and an oxygen pump cell 140.

The oxygen concentration detection cell 130 is composed of: a first solid electrolyte 105; and a first electrode 104 and a second electrode 106 formed at both faces of the first solid electrolyte 105. The first electrode 104 is composed of: a first electrode portion 104a; and a first lead portion 104b extending from the first electrode portion 104a along the longitudinal direction (the direction of the axial line L) of the first solid electrolyte 105. The second electrode 106 is composed of: a second electrode portion 106a; and a second lead portion 106b extending from the second electrode portion 106a along the longitudinal direction (the direction of the axial line L) of the first solid electrolyte 105.

An end of the first lead portion 104b is electrically connected to a detection-element-side pad 121 via a conductor formed in each of a first through-hole 105a provided in the first solid electrolyte 105, a second through-hole 107a provided in an insulation layer 107 described later, a fourth through-hole 109a provided in a second solid electrolyte 109, and a sixth through-hole 11a provided in a protection layer 111. An end of the second lead portion 106b is electrically connected to a detection-element-side pad 121 via a conductor formed in each of a third through-hole 107b provided in the insulation layer 107 described later, a fifth through-hole 109b provided in the second solid electrolyte 109, and a seventh through-hole 111b provided in the protection layer 111.

Here, the first electrode portion 104a and the second electrode portion 106a correspond to “a pair of electrodes” in the claims. The first lead portion 104b corresponds to “one of the pair of leads (internal lead)” in the claims.

And, the first through-hole 105a, the second through-hole 107a, the fourth through-hole 109a, and the sixth through-hole 111a correspond to “a communication hole” in the claims.

The oxygen pump cell 140 is composed of: the second solid electrolyte 109; and a third electrode 108 and a fourth electrode 110 formed at both faces of the second solid electrolyte 109. The third electrode 108 is composed of: a third electrode portion 108a; and a third lead portion 108b extending from the third electrode portion 108a along the longitudinal direction (the direction of the axial line L) of the second solid electrolyte 109. The fourth electrode 110 is composed of: a fourth electrode portion 110a; and a fourth lead portion 110b extending from the fourth electrode portion 110a along the longitudinal direction (the direction of the axial line L) of the second solid electrolyte 109.

An end of the third lead portion 108b is electrically connected to a detection-element-side pad 121 via a conductor formed in each of the fifth through-hole 109b provided in the second solid electrolyte 109 and the seventh through-hole 111b provided in the protection layer 111. An end of the fourth lead portion 110b is electrically connected to a detection-element-side pad 121 via a conductor formed in an eighth through-hole 111c provided in the protection layer 111. The second lead portion 106b and the third lead portion 108b have the same electric potential.

The first solid electrolyte 105 and the second solid electrolyte 109 are each formed from a partially stabilized zirconia sintered body obtained by adding yttria (Y₂O₃) or calcia (CaO) as a stabilizer to zirconia (ZrO₂).

The heating element 102, the first electrode 104, the second electrode 106, the third electrode 108, the fourth electrode 110, the heater-side pads 120, and the detection-element-side pads 121 can be formed from elements of the platinum group. Examples of suitable elements of the platinum group for forming these include Pt, Rh, Pd, and the like. These elements of the platinum group may be used alone or in a combination of two types or more.

Preferably, the above heating element 102 and the like are mainly formed from Pt from the viewpoints of heat resistance and oxidation resistance. In addition, preferably, the above heating element 102 and the like contain a ceramic component other than the element of the platinum group serving as a main component. From the viewpoint of fixation, this ceramic component is preferably a component that is similar to the material serving as a main component on the side on which these members are stacked.

The insulation layer 107 is formed between the oxygen pump cell 140 and the oxygen concentration detection cell 130 described above. The insulation layer 107 is composed of an insulating portion 114 and a diffusion resistance portion 115. In the insulating portion 114 of the insulation layer 107, a hollow measurement chamber 107c is formed at a position corresponding to the second electrode portion 106a and the third electrode portion 108a. The measurement chamber 107c is in communication with the outside in the width direction of the insulation layer 107. In each of the communicating portions, the diffusion resistance portion 115 which realizes gas diffusion between the outside and the measurement chamber 107c under a predetermined rate controlling condition is disposed.

The insulating portion 114 is not limited as long as the insulating portion 114 is a ceramic sintered body having insulating property, and is formed from an oxide-based ceramic or the like such as alumina or mullite, for example.

The diffusion resistance portion 115 is a porous body formed from alumina, and the speed of a detection gas flowing into the measurement chamber 107c is adjusted by the diffusion resistance portion 115 formed as a porous body.

At a surface of the second solid electrolyte 109, the protection layer 111 is formed so as to sandwich the fourth electrode 110 therebetween. The protection layer 111 is composed of: a porous electrode protection portion 113a for preventing the fourth electrode portion 110a from being poisoned, in such a manner that the fourth electrode portion 110a is sandwiched; and a reinforcing portion 112 for protecting the second solid electrolyte 109 in such a manner that the fourth lead portion 110b is sandwiched. The sensor element 100 of the present embodiment is an oxygen sensor element in which: the direction and magnitude of the current flowing between the electrodes of the oxygen pump cell 140 are adjusted such that the voltage (electromotive force) generated between the electrodes of the oxygen concentration detection cell 130 has a predetermined value (e.g., 450 mV); and the oxygen concentration in the measurement target gas corresponding to the current flowing in the oxygen pump cell 140 is linearly detected.

Here, a cross section of the sensor element 100 perpendicular to the direction of the axial line L is a cross section having a rectangular shape of which the long sides are the outer edges formed by the protection layer 111 and the first base body 101 and of which the short sides are two sides along the stacking direction of the protection layer 111 and the first base body 101.

With reference back to FIG. 1, the metal shell 30 is made of SUS430, and includes: an external thread portion 31 for attaching the gas sensor 1 to an exhaust pipe; and a hexagonal portion 32 at which an attachment tool is put at the time of the attachment. In addition, the metal shell 30 is provided with a metal-shell-side step portion 33 protruding toward the radially inner side. The metal-shell-side step portion 33 supports a metal holder 34 for holding the sensor element 100. On the inner side of the metal holder 34, a ceramic holder 35 and a talc 36 are disposed in this order from the front end side.

The talc 36 is composed of a first talc 37 disposed in the metal holder 34, and a second talc 38 disposed at the rear end of the metal holder 34. The first talc 37 is filled and compressed in the metal holder 34, whereby the sensor element 100 is fixed with respect to the metal holder 34. In addition, the second talc 38 is filled and compressed in the metal shell 30, whereby sealability between the outer surface of the sensor element 100 and the inner surface of the metal shell 30 is ensured.

A sleeve 39 made of alumina is disposed on the rear end side of the second talc 38. The sleeve 39 is formed in a multi-stepped cylindrical shape, and an axial hole 39a is provided so as to extend along the axial line L. The sensor element 100 is inserted into the sleeve 39 including the axial hole 39a. A crimping portion 30a on the rear end side of the metal shell 30 is bent inwardly, and the sleeve 39 is pressed by the crimping portion 30a toward the front end side of the metal shell 30 via a stainless steel ring member 40.

A protector 24 made of metal is attached by welding to the outer periphery on the front end side of the metal shell 30. The protector 24 has a double structure. On the outer side of the protector 24, an outer protector 41 in a bottomed cylindrical shape having a uniform outer diameter is disposed. On the inner side of the protector 24, an inner protector 42 in a bottomed cylindrical shape formed such that the outer diameter of a rear end portion 42a is larger than the outer diameter of a front end portion 42b is disposed. The protector 24 covers a front end portion, of the sensor element 100, protruding from the front end of the metal shell 30, and has a plurality of gas taking-in holes 24a.

The rear end side of the metal shell 30 is inserted in the front end side of an outer casing 25 made of SUS430. The outer casing 25 includes a front end portion 25a of which the front end side has an enlarged diameter. The front end portion 25a is fixed to the metal shell 30 by laser welding or the like. A separator 50 is disposed in the inside on the rear end side of the outer casing 25. A holding member 51 is interposed in a gap formed between the separator 50 and the outer casing 25. The holding member 51 is engaged with a protruding portion 50a protruding outward from the peripheral surface of the separator 50, and is fixed between the separator 50 and the outer casing 25 having been crimped.

The separator 50 is provided with insertion holes 50b for inserting various types of lead wires 11, 12, 13 for the detection element portion 300 and for the heater portion 200 such that the insertion holes 50b penetrate the separator 50 from the front end side to the rear end side. In FIG. 1, for convenience of description, only three lead wires 11, 12, 13 are shown, and the other lead wires are not shown. Connection terminals 16 which connect the above lead wire 11, etc., and the detection-element-side pads 121 of the detection element portion 300 and the heater-side pads 120 of the heater portion 200 are accommodated in the insertion hole 50b. Each lead wire 11, etc., is configured to be connectable, at the outside, to a connector (not shown), and input/output of an electric signal is performed between an external device such as an ECU and each lead wire 11, etc., via the connector.

Further, a rubber cap 52 having a substantially circular column shape and for closing an opening 25b on the rear end side of the outer casing 25 is disposed on the rear end side of the separator 50. The rubber cap 52 is fixed to the outer casing 25, by the outer casing 25 being crimped toward the radially inner side in a state where the rubber cap 52 is accommodated in the rear end of the outer casing 25. The rubber cap 52 is also provided with insertion holes 52a for respectively inserting the lead wire 11 and the like such that the insertion holes 52a penetrate the rubber cap 52 from the front end side to the rear end side.

Next, the first lead portion 104b being a characteristic part of the present invention will be described.

The first lead portion 104b is formed of a gas permeable porous body including pores, and faces communication holes (the first through-hole 105a, the second through-hole 107a, the fourth through-hole 109a, and the sixth through-hole 11a) provided in the sensor element 100, to be in communication with the outside. The detection-element-side pad 121 that is electrically connected to the sixth through-hole 111a is also formed of a gas permeable porous body.

A reference gas generated at the first electrode portion is discharged to the outside via the first lead portion 104b and the communication holes.

In this case, if water has entered the sensor element 100, the first lead portion 104b absorbs the water having entered through the communication holes, and when the sensor element 100 is heated thereafter, water vaporizes and expands inside the first lead portion 104b, whereby breakage or disconnection of the first lead portion 104b may be caused.

Therefore, in the present invention, the first lead portion 104b is configured to include: noble metal particles of one type or more selected from the group of Pt, Pd, Rh, and Au; ceramic particles; and pores, wherein the porosity is more than 0% and 11% or less, and a proportion RA of the total area of large-diameter pores each having a cross-sectional area of 5 μm² or more relative to the total area of pores in a cross section accounts for 8% or more.

The reason why the porosity of the first lead portion 104b is more than 0% is that, if the first lead portion 104b does not have pores, the first lead portion 104b becomes gas-impermeable, and thus becomes unable to adjust the pressure of the reference gas from the first electrode portion 104a.

Meanwhile, when the porosity of the first lead portion 104b is higher, the gas more easily passes therethrough, but if the porosity exceeds 11%, noble metal particles being a conductor in the first lead portion 104b are divided by pores, whereby disconnection easily occurs.

The porosity is preferably 5% or more and more preferably 8% or more.

Further, in the first lead portion 104b, when the proportion RA of the total area of the large-diameter pores each having a cross-sectional area of 5 μm² or more relative to the total area of pores in a cross section accounts for 8% or more, water absorbed in the first lead portion 104b from the large-diameter pores is easily released toward the communication holes.

As a result, it is possible to suppress an incident that, when heating is performed after water has entered the sensor element 100, water vaporizes and expands inside the first lead portion 104b to cause breakage or disconnection of the first lead portion 104b.

It is preferable that the proportion RA is less than 60%. When the proportion RA is 60% or more, peeling off of the first lead portion 104b may be caused.

The RA is more preferably 40% or less, further preferably 30% or less, and most preferably 21.6% or less.

The RA is preferably 10% or more, more preferably 15% or more, and most preferably 20% or more.

The range of the RA is preferably 10 to 40%, further preferably 15 to 30%, and most preferably 20 to 21.6%, for example.

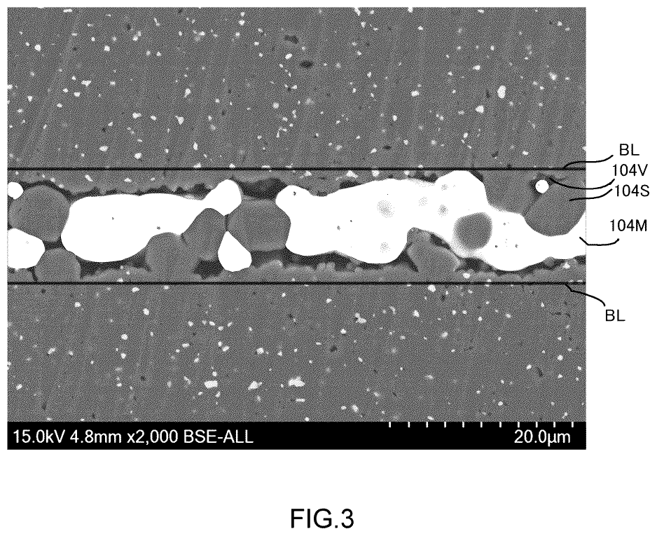

A measurement method for the porosity of the first lead portion 104b is performed based on a cross-sectional SEM image including the first lead portion 104b as shown in FIG. 3. FIG. 3 is a cross-sectional SEM image of Example described later.

First, the cross-sectional SEM image is binarized to extract (binarization software: ImageJ) pores 104V being a void part, and calculates the area of each individual pore and the number of pores per area, based on an Analyze Particle command.

The pores 104V are the darkest portion in the cross-sectional SEM image, and noble metal particles 104M forming the first lead portion 104b are the lightest portion. Ceramic particles 104S forming the first lead portion 104b have an intermediate lightness.

Next, from an end portion of a pore 104V, among the pores 104V, that connects to the noble metal particles 104M and that is on the outermost side (the up-down direction in FIG. 3) in the thickness direction of the first lead portion 104b, a parallel line BL is drawn in the plane direction (the left-right direction in FIG. 3) of the first lead portion 104b. The parallel line BL is drawn on each of the upper side and the lower side of the first lead portion 104b.

Then, the region of the cross-sectional SEM image between the two parallel lines BL is regarded as the cross-sectional area of the first lead portion 104b, and the porosity is calculated from the total area of the pores 104V.

Among the pores 104V, those that do not connect to the noble metal particles 104M (i.e., far from the noble metal particles 104M relative to the parallel lines BL) can be considered to be cavities inside the other layers adjacent to the first lead portion 104b, and thus, are excluded.

In a case where, relative to the pores 104V that connect to the noble metal particles 104M, another noble metal particle 104M is positioned on the outermost side in the thickness direction, the position of the noble metal particle 104M is used as the position of the parallel line BL.

The total area of the large-diameter pores each having a cross-sectional area of 5 μm² or more in the cross section of the first lead portion 104b is calculated by creating a histogram based on the number per area of individual pores 104V subjected to the image analysis as described above. Then, from the total area of pores subjected to the image analysis as described above, the proportion RA of the total area of the large-diameter pores is calculated.

It is needless to say that the present invention is not limited to the above-described embodiment, but is applicable to various modifications and equivalents encompassed in the idea and the scope of the present invention.

The gas sensor is not limited to the oxygen sensor, but may be a NOx sensor.

### EXAMPLE

A plurality of the sensor elements 100 shown in FIG. 1 and FIG. 2 were produced by using Pt as the noble metal particles of the first lead portion 104, using alumina as the ceramic particles, and changing the porosity of the first lead portion 104 in various ways.

Each obtained sensor element 100 was immersed in water to cause water to enter the first lead portion 104, and then, the resultant first lead portion 104 was dried. Next, the heater portion 200 of the sensor element 100 was driven to raise the temperature to a predetermined temperature, and the puncture(disconnection) rate of the first lead portion 104 was measured through a characteristic inspection. The disconnection rate indicates the proportion at which breakage or disconnection of the lead occurs.

With respect to sensor elements 100 of the same lot (for which the disconnection rate was not measured) as that of the sensor element 100 for which the disconnection rate was measured, a cross-sectional SEM image including the first lead portion 104 was taken. Based on this cross-sectional SEM image, the porosity of the first lead portion 104 and the proportion RA of the total area of the large-diameter pores were calculated through the image analysis described above.

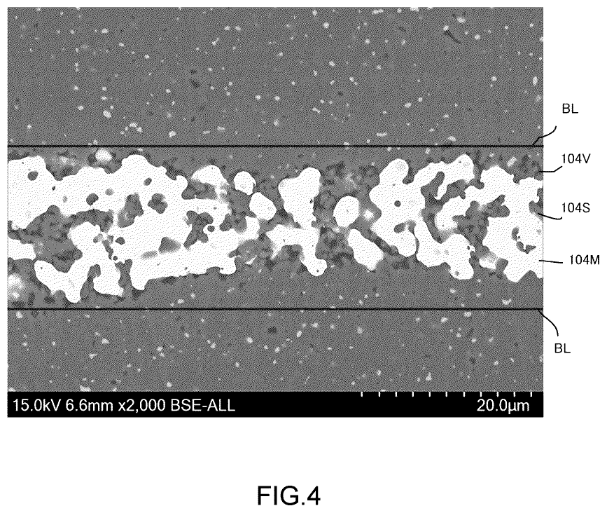

The obtained results are shown in Table 1, FIG. 3, and FIG. 4.

TABLE 1

| | Porosity | Proportion of the total area | Disconnection |
|---|---|---|---|
| | (%) | of the large-D pores RA(%) | rate (%) |
| Example1 | 10.1 | 21.6 | 0 |
| Comp-Ex1 | 8.4 | 0 | 100 |
| Comp-Ex2 | 9.2 | 0 | 100 |
| Comp-Ex3 | 11.2 | 8.3 | 83 |

As shown in Table 1, in the case of Example 1 in which the porosity was 11% or less and the proportion RA of the total area of the large-diameter pores was 8% or more, the disconnection rate was 0%, and breakage or disconnection of the lead was suppressed.

On the other hand, in the cases of Comparative Examples 1, 2 in which the porosity was 11% or less but the proportion RA of the total area of the large-diameter pores was less than 8%, the disconnection rate was 100%, and breakage or disconnection of the lead occurred.

Also, in the case of Comparative Example 3 in which the proportion RA of the total area of the large-diameter pores was 8% or more but the porosity exceeded 11%, the disconnection rate was high and breakage or disconnection of the lead occurred.

FIG. 3 and FIG. 4 are cross-sectional SEM images including the first lead portion 104 of Example 1 and Comparative Example 1, respectively. It is seen that the cross-sectional area of individual pores 104V is smaller in Comparative Example 1, and absorbed water is less likely to be released.

### DESCRIPTION OF REFERENCE NUMERALS

1: gas sensor
30: metal shell
100: sensor element
104a: first electrode portion(a pair of electrodes)
104b: first lead portion (one of the pair of leads (internal lead)
104M: noble metal particle
104S: ceramic particle
104V: pore
105a: first through-hole (communication hole)
106a: second electrode portion(a pair of electrodes)
106b: second lead portion (a pair of leads)
107a: second through-hole(communication hole)
109a: fourth through-hole(communication hole)
11a: sixth through-hole (communication hole)

What is claimed is:

1. A sensor element comprising:
a pair of electrodes; and
a pair of leads respectively connected to the pair of electrodes, wherein
one of the pair of leads is an internal lead disposed inside the sensor element,
a part of the one of the pair of leads faces a communication hole provided in the sensor element and communicates with an outside,
the internal lead is configured to include noble metal particles, ceramic particles and pores, said noble metal particles being one or more elements selected from the group consisting of Pt, Pd, Rh, and Au,
a porosity of the internal lead is in a range of more than 0% and 11% or less, and
a proportion RA of a total area of large-diameter pores each having a cross-sectional area of 5 μm² or more relative to a total area of the pores in a cross section of the internal lead accounts for 8% or more.

2. The sensor element according to claim 1, wherein the proportion RA is less than 60%.

3. A gas sensor comprising:
the sensor element according to claim 1; and
a metal shell holding the sensor element.
